(19) United States
(12) Patent Application Publication
(10) Pub. No.: US 2023/0267835 A1
(43) Pub. Date: Aug. 24, 2023

(54) APPARATUS AND METHOD FOR VEHICLE AND ENVIRONMENTAL DATA INTEGRATION

(71) Applicant: Jeffrey R. Ambroziak, Guilford, CT (US)

(72) Inventor: Jeffrey R. Ambroziak, Guilford, CT (US)

(21) Appl. No.: 18/173,628

(22) Filed: Feb. 23, 2023

Related U.S. Application Data
(60) Provisional application No. 63/313,508, filed on Feb. 24, 2022.

(51) Int. Cl. G08G 1/0967; G07C 5/00

(52) U.S. Cl. CPC G08G 1/096791; G07C 5/008

(57) ABSTRACT

A method includes receiving geocoded status data from a plurality of sensors forming a part of a plurality of vehicles the geocoded status data being indicative of an environmental attribute of each of the plurality of vehicle’s location, receiving geocoded weather data indicative of a weather phenomena over a geographic expanse, determining based, at least, on the geocoded status data and the geocoded weather data, one or more road status attributes and transmitting the road status attributes to at least one of the plurality of vehicles for display to a driver of each of the plurality of vehicles.

### CROSS REFERENCE TO RELATED APPLICATIONS

The present patent application claims the benefit of U.S. Provisional Pat. Application 63/313,508, filed Feb. 24, 2022 the entire disclosures of which is hereby incorporated herein by reference.

### TECHNICAL FIELD

The present disclosure relates generally to an apparatus and method for gathering and integrating environmental route information.

### BACKGROUND

With the advent of smartphone based GPS and cellular connectivity, it is now common for smartphones to report their locations periodically when in a car. Speeds derived from the location information of thousands of such smartphones may be used to determine traffic conditions throughout a road network. This information may be visually displayed as a map overlay to users/drivers using a GPS system and/or utilized to aid in efficient route planning, either automated or manual in nature.

One advantage of such a system is that most drivers carry their phones with them wherever they go. As a result, the system may function without any need to be compatible with any particular type of car. In fact, even a classic car having entirely analog systems and no access to GPS may act as a source of data if the driver is carrying a cell phone while driving.

One negative aspect of the art is that, while position information is available from smart phones and requires no interaction with the automobile in which the phone is travelling, many cars acquire and store information that may be useful in determining driving conditions that would be useful to other drivers if collected and disseminated, such as to a server or servers, for distribution to other drivers.

What is therefore needed is a system for collecting and, when appropriate, aggregating data pertaining to and collected by individual vehicles in order to provide other drivers with up to date and relevant information related to environmental factors such as, for example, road conditions. In particular, there is needed a system and method for imparting such large volumes of accessible data to a driver without burdening and overloading the driver’s ability to concentrate on operating the vehicle.

### SUMMARY

In accordance with an exemplary and non-limiting embodiment, a method includes receiving geocoded status data from a plurality of sensors forming a part of a plurality of vehicles the geocoded status data being indicative of an environmental attribute of each of the plurality of vehicle’s location, receiving geocoded weather data indicative of a weather phenomena over a geographic expanse, determining based, at least, on the geocoded status data and the geocoded weather data, one or more road status attributes and transmitting the road status attributes to at least one of the plurality of vehicles for display to a driver of each of the plurality of vehicles

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIGS. 1A-1C are illustrations of an exemplary and non-limiting embodiment of a graphical element for displaying environmental route data.

FIG. 2 is an illustration of an exemplary and non-limiting embodiment of a graphical element for displaying environmental route data.

FIG. 3 is an illustration of an exemplary and non-limiting embodiment of the fusion of environmental route data with the interior of a vehicle.

FIGS. 4A-4C are illustrations of exemplary and non-limiting embodiments of environmental data representations.

FIG. 5 is illustrations of an exemplary and non-limiting embodiment of a route environment.

### DETAILED DESCRIPTION

In some embodiments, sensors may detect variables indicative of the operation of automobile systems, such as, for example and without limitation, the status of windshield wipers, the occurrence and intensity of anti-lock braking engagement, indications from inertial measurement units (IMUs) and the like. These sensors permit an automobile to function as a mobile data collector from which the condition of the automobile and the environment in which it operates may be determined. Many areas of the country are covered by Doppler radar. The output of Doppler radar systems typically takes the form of a map of an area at least partially covered by the radar over which is displayed the motion of precipitation. If one were to secure this data in real or near real time and provide it as a layer over a GPS display showing a proposed route for the automobile, a driver may be able to glean some information as to the weather conditions present along his proposed route.

However, even if one knows with precision the intensity of precipitation in an area through which a route proceeds, it is one step further removed to correlate such weather information to actual road conditions. For example, if a driver sees before heading out that Doppler radar indicates that a stretch of highway along an expected route is likely to be encountering precipitation, he may infer, correctly or erroneously, that the precipitation is likely to cause adverse driving conditions along the stretch. In contrast, if the system is updated with data derived from cars traveling along the stretch in near real-time, the system may display information indicative of the actual road conditions along stretches and portions of roads.

Adverse environmental conditions, which may be of particular interest to a driver, may not require the aggregation of data from multiple vehicles in order to be relevant. For example, a single car experiencing a single exception condition wherein the anti-lock braking mechanism is employed may be of significant importance. In instances where the system operates to retrieve additional information, the combination of retrieved data and the exception condition may yield insight into the nature of the condition.

For example, if weather data indicates that an outside temperature around the car is approximately 70° F., the occurrence of the operation of an anti-lock braking system may be ascertained to more likely be the result of breaking on a road surface covered with leaves, particularly if the location of the vehicle is in the northeast during the month of November. Note that the weather data may alternatively be retrieved from an outdoor temperature sensor of the vehicle. Conversely, if weather data indicates that an outside temperature around the car is approximately 27° F. and there is or recently has been precipitation, the occurrence of the operation of an anti-lock braking system may be ascertained to more likely be the result of ice on the road.

The system may include various other sensor readings sent from a vehicle to aid in determining the nature of an exception condition. For example, information transmitted by and received from a vehicle indicating the windshield wipers are activated so as to be operating at a relatively high speed in a back and forth motion is, generally, indicative of precipitation at the location of the vehicle. In the example above, the temperature of 27° F. combined with evidence of precipitation may indicate the probability of icy road condition arising from blizzard conditions. In the instance that the temperature is determined to be approximately 70° F. and the windshield rate is only intermittent, the degree of danger posed by the exception condition may be downgraded. Likewise, if there is data retrieved from the vehicle indicating extraneous factors, such as a high rate of speed and/or a sharp turning radius, the system may determine that the exception condition is likely the result of factors unique to the driver’s operation of the vehicle (e.g., traveling too fast, taking turns at too high a rate of speed, etc.) and may determine that there is no relevant diminution in the driving conditions.

As noted above, vehicles are traveling sensor platforms that regularly query the environment around them either directly or indirectly. In addition to the direct measurement of temperature around a vehicle, environmental conditions may be inferred and otherwise determined from other vehicle attribute information including, but not limited to, windshield wiper use, windshield wiper speed, anti-lock brake application, defroster activation, interior temperature settings, convertible top configuration, tire pressure and the like. Such data may be transmitted by a vehicle automatically from the vehicle to a server via any form of network and/or may be gathered and transmitted via a dongle such as an OBDII-device acting alone or in coordination with an app running on an electronic device in communication with the dongle and the server.

With the enhanced capability described above to acquire, process and disseminate vehicle environment information, exemplary and non-limiting embodiments are presented whereby such information is effectively communicated to the driver of a vehicle. For example, it is common place for data aggregated from a plurality of cellular phones traveling in multiple vehicles to be used to identify traffic conditions. Typically, stretches of road that are experiencing slowdowns and/or stoppages are presented in yellow and red, respectively. While helpful, this visual indicia of traffic conditions is relatively small and could very well evade the notice of a driver.

Typically, traffic data is displayed in two manners. First, as noted above, color coded traffic congestion is displayed along a predetermined route in proximity to the location of a vehicle. Second, as when plotting a route, GPS displays often show a bird’s eye view of the prospective route showing the beginning and ending points with traffic congestion color coded along the suggested route. In the first instance, as a driver travels, data is known indicating nearby future traffic conditions while is not imparting more distant congestion data to the driver. In the second instance, the data is displayed as a static snapshot and is in the form of a two-dimensional map.

In neither case is all the data available and useful to the driver provided in a manner that accords with the brain’s perception of a journey being a predominantly one dimensional entity. Specifically, people tend to envision a journey as extending from a starting point in time and space to another ending point in time and space with little concern for the latitudinal, longitudinal or elevational deviations through three dimensional space. There is therefore presented a method of displaying relevant trip data to a driver in a manner that is dynamic and provides the driver with an updated sense of the status of a journey over the course of the journey.

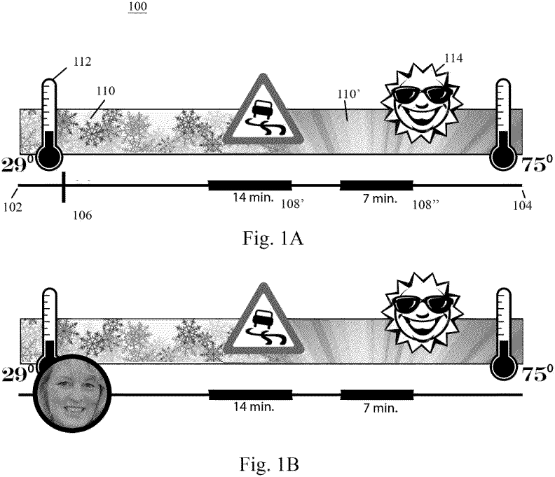

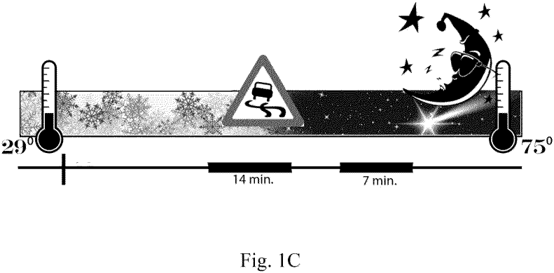

With reference to FIG. 1A, there is illustrated an exemplary and non-limiting embodiment of a graphical element 100 for synthesizing trip data for display to a driver. The graphical element 100 may be displayed in any manner upon any surface of an interior of a vehicle or may be projected such as with a heads-up display (HUD). Many cars include a display screen in the center console position embodiments, the steering wheel, dashboard panels, door panels, seatbacks, and the like, may be fitted with displays so as to operate as display surfaces.

Graphical element 100 is primarily one dimensional and extends, in the present example, from starting point 102 to ending point 104. As shown, the vehicle has proceeded a ways along the route to present location 106. Such a route may be computed using a GPS system and based, in part, on a location of a vehicle and a desired destination point. While the actual route, neglecting the z-axis or elevation component, covers a two-dimensional map, graphical element 100 effectively stretches out the route into a straight line extending from starting point 102 to ending point 104.

Multidimensional data is displayed in an intuitive manner to the driver at a glance. As illustrated, the nature of the projected route spans linearly from left to right. Various graphical sub-elements provide a clear and easily understood summation of the nature of journey. In the present example, progress indicator 106 indicates that the driver has traversed approximately 5% to completion of the journey. Progress indicator 106 may take any form that symbolizes the vehicle for purposes of illustrating the progress of the vehicle from starting point 102 to ending point 104. For example, progress indicator 106 may be a circle and may be a dynamic element. Progress indicator 106 may be comprised of a circle within which is a picture of the singer or band logo for the performer whose music is playing on the vehicle sound system. Similarly, progress indicator 106 may be comprised of a circle within which is a picture of a caller with whom the driver is conversing as illustrated with reference to FIG. 1B. When displayed on a touch screen, graphical sub-elements can be used to obtain more data or control the system. For example, when a call comes in, the progress indicator may appear in circular form with a photo of the caller. It may blink until the driver touches it to answer the call. During the call, touching the progress indicator 106 may provide additional information about the caller or allow one to hang up.

Note that the result is that graphical element 100 continues to provide a one stop, at-a glance overview of the trip while dynamically updating elements to draw attention to aspects of the trip that exist in importance in the present, such as a caller.

Traffic indicators 108′, 108″ indicate that upcoming traffic congestion will add approximately 14 minutes and 7 minutes, respectively, to the trip. While illustrated in black and white, any or all of the graphical sub-element may be color-coded to draw attention and provide information. Similarly, graphical sub-elements may blink or alter their appearance to likewise provide information.

As illustrated, temperature icon 112 indicates a temperature of 29 degrees near the starting of the trip. This data may be extracted from the system based on temperature readings from other vehicles as described above. Environment indicator 110 extends a distance similar to and correlated with the span from starting point 102 to ending point 104 while located just above. As shown, as the trip commences, snowy weather will give way to sunny weather culminating in a temperature of 75 degrees at the destination. Weather icon 114 indicates it is daytime with the sun in the sky near the end of the trip. At approximately the half-way point, hazardous road conditions will predominate. As described above, this information may be the result of aggregating windshield wiper speeds for numerous geotagged vehicles, receiving information of the activation of antilock brake systems, receiving data from accelerometers, etc.

Note that the display of information in graphical element 100 is dynamic and seeks to display a continually updated view of a planned trip. Unlike typical route planners and mapping systems, the present system is more directed, though not exclusively, to providing a description of trip factors over a distance as opposed to a time. Graphical element 100 operates to describe the conditions over a linear expanse comprising an itinerary without specific emphasis on when any given point along the itinerary will be traversed. As will be described, there are instances when such time dependent information, such as vehicle charging times, may be integrated into graphical element 100.

As a result, and with reference to FIG. 1C, there is shown graphical element 100 of FIG. 1A as the day commences. Perhaps, for example, upon encountering the hazardous road conditions, the driver pulls over to a restaurant for several hours. Upon starting the car once again, graphical element 100 is updated to appear as described. Note that weather icon 114 indicates it is nighttime with the moon in the sky near the end of the trip. Touching on weather icon 114 may provide information about sunrise and sunset times at the end point of the trip. In other instances, via a process of continually updating the graphical element 100 with the newest weather data, the driver is made aware of passing storms and the like occurring at present along a projected route.

In some instances, a circular magnifying glass icon may be inserted, as, for example, progress indicator 106, inside of which may be displayed additional information. As described, graphical element 100 extends along a primarily linear expanse. In some instances, graphical element may be positioned either horizontally or vertically nearby and in conjunction with a GPS mapping display.

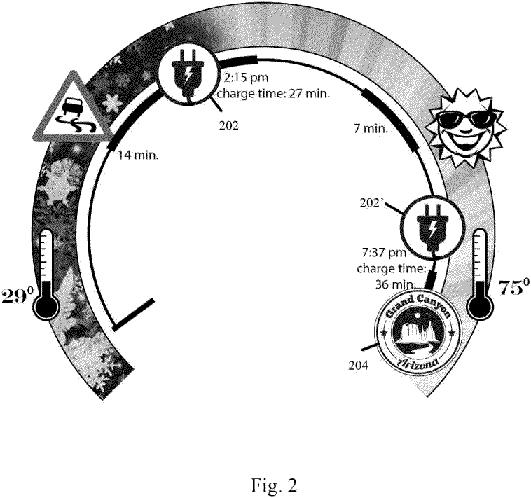

With reference to FIG. 2, there is illustrated an exemplary and non-limiting embodiment of a generally circular graphical element 100. Note that progress indicator 106 now moves in a clockwise direction from a starting point to an ending point. In addition to the elements described previously, there are now illustrated charge stations 202, 202′. When used in conjunction with a GPS route planner, the location, status, and timing of such charge stops may be displayed and continually updated. Note further that end icon 204 displays data related to the trip end point. In the present instance, the route was defined as extending to the Grand Canyon National Park. As a result, a visual indicator of the park is displayed. In other instances, such as when seeking directions to a grocery store or a museum, the system may operate to extract an appropriate icon for display. In some instances, the system may utilize a generic icon, such as for a high school, and dynamically overlay text such as “Lake Braddock High School” as appropriate.

In other instances, the system may extract both historical and real-time location information of people and/or objects of interest for display along the route. For example, the system may ascertain from social media or cell phone data the home addresses and/or present locations of numerous contacts of the driver that fall within a predetermined distance of the route. The contacts may be displayed as icons, similar to weather icon 114, along the graphical element 100. In a default mode, the person’s initials may be displayed. In other instances, a thumbnail of the person may be displayed. Touching the displayed person data may bring up options such as the ability to call the person, to provide directions to the person’s location and the like.

In some instances, a driver profile, either explicitly entered by the driver, gleaned from social media, surmised from past actions or some combination thereof, may be used to select data for display. For example, a driver with an express interest in colonial history traveling from Connecticut to Virginia may be passing within five miles of the Liberty Bell. As a result, an icon of the Liberty Bell may be displayed on the graphical element 100 at a point corresponding to Philadelphia along the route.

One advantage of the circularly shaped graphical element 100 is that it may be coupled with the display of other data from other systems. For example, a perspective GPS map of the proximate route may be displayed within the semi-circular shape of the graphical element 100. The display of both may be on a dashboard in front of the driver. In other instances, the combined or singular graphical element 100 may be displayed such as on the back of the front seats for viewing by rear passengers. In such instances, the graphical element 100 displayed icons may be customized using profile data of the particular passenger with which the display is associated. In the above example, while the driver is made aware of the location of the Liberty Bell, the driver’s son behind him may be made aware of a dinosaur museum along the route

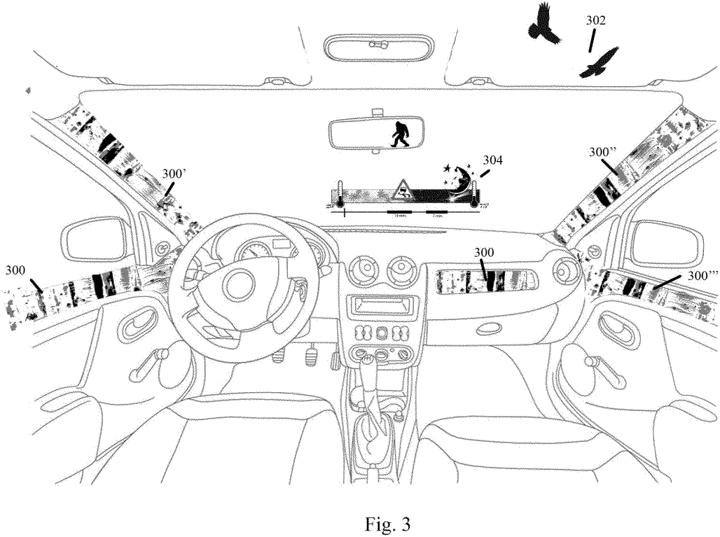

In accordance with exemplary embodiments, multidimensional vehicle environmental data may be presented in an intuitive manner utilizing audio and visual cues. With reference to FIG. 3 there is illustrated an exemplary and non-limiting embodiment of data display within the interior of a vehicle. In some embodiments, surfaces of a vehicle including, but not limited to dashboard, door surfaces, ceiling panels, sun visors, windows and windshields may be utilized. In particular, windshields may be utilized via the operation of a Heads-Up-Display (HUD). Display surfaces may be realized via any technology for displaying a pixelated or digital image on a surface including, but not limited to, LED displays, electronic paper, and the like. In some embodiments, representations of extra-vehicle environmental conditions may be presented to the driver in a manner that induces a feeling for the environment and road conditions without the driver being conscious of the transmission of information.

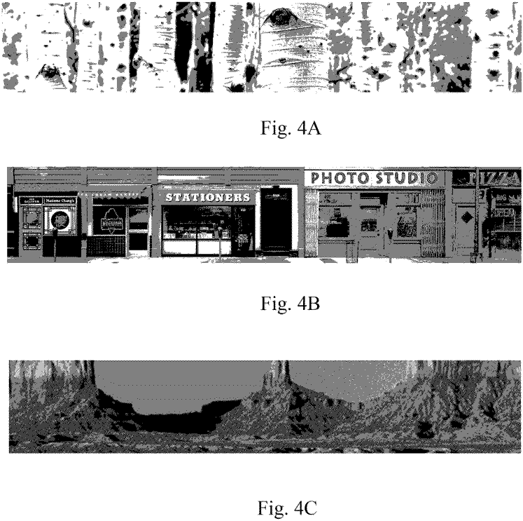

For example, when driving on a highway through New England, an abstracted representation of birch trees may be displayed moving across the dashboard and wrapping around the door panels and display surfaces 300^{i-iv}. In some instances, the speed at which the trees appear to move, such as radially outwards from a central point on the dashboard, is proportional to present traffic speed or projected traffic speed. As the driver whisks along the highway enjoying seeing actual birch trees on either side of the highway, a feeling of congruence between the display and what is actually seen produces no reaction in the driver. If, then, the system determines that traffic will be slowing substantially in about a quarter mile (or approximately 15 seconds), the speed at which the trees are displayed as moving across the interior cabin may slow down. This change in the relative display movement speed prepares the driver quite naturally to begin to slow down. In other instances, abstracted cityscapes, desert environments, as illustrated in FIGS. 4A-4C, and the like may be displayed depending on a determination of the nature of the outside physical environment.

As noted, the data displayed may be multidimensional. Returning to the birch tree example, the abstracted display may be rendered in different hues of blue to reflect outdoor temperature. Likewise, saturation and intensity may be altered to impart data using orthogonal modalities.

In other embodiments, sound may be employed to impart data to a driver. For example, a car invokes its anti-lock braking system on a stretch of road. Automobile sensors record that outside air temperature is below freezing and weather reports indicate that there was recently precipitation at the automobile’s location. As a result, the system stores in the cloud or on a central server accessible to the vehicle and forming a part of the system information indicative of that stretch of road presenting hazardous driving conditions. When, half an hour later, another car is nearing the stretch of road, the display of birch trees may be tilted toward bright blue, their speed of movement decreased and the subtle sound of ice cracking or crunching may be played at a low volume. These separate actions all work in concert to produce a feeling of caution requiring a reduction in speed owing to icy conditions.

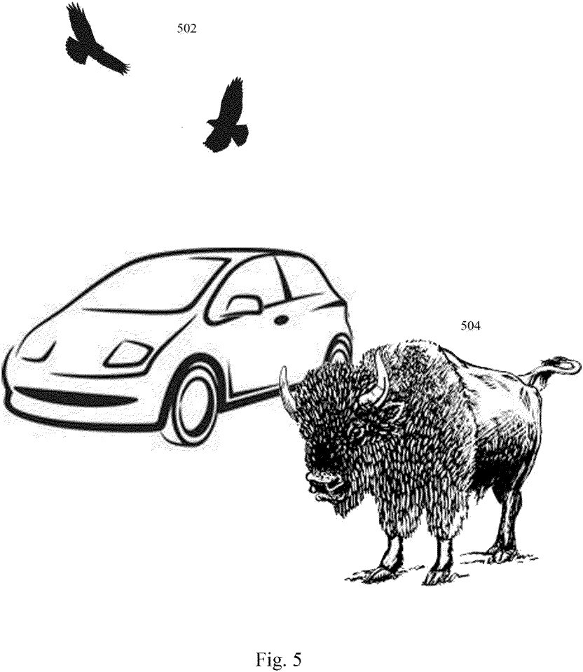

In other embodiments, data may be displayed in a manner that intensifies or otherwise augments a driver’s connection with the road and environment. One aspect of riding a motorcycle that is often deemed preferable to driving a car is the feeling that the driver of a motorcycle feels more a part of the environment. With the advent of numerous cameras located on and about a car, it is possible to observe cues in the surrounding environment and impart information indicative of the environment to the driver. With reference to FIG. 5, there is illustrated an exemplary and non-limiting embodiment of a scenario wherein a vehicle equipped with cameras looking outwards is able to see and identify the presence of hawks 502 and a bison 504.

With continued reference to FIG. 3, if a bird of prey is observed by a car mounted camera, the sound of a hawk or eagle calling out may be played in the interior of the car. As illustrated, patterns 302 indicative of circling hawks are displayed upon an interior display located on a sun visor. Likewise, if a herd of cattle or bison 504 are observed, appropriate sounds related to either may likewise be played or patterns sufficient to conjure up a feeling of the presence of the animals may be displayed. When the car passes a diner, the sounds of dishes clinking and patrons chatting may be played in some manner. In various instances, these sounds take their identities from elements existing in the environment in proximity to the car and serve to subliminally enhance the driver’s attachment to the environment. Note that in FIG. 3, graphical element 100 is displayed to the driver via HUD 304.

Because electric car engines produce little or no sound, it is not uncommon for electric cars to play the artificial sound of a gas combustion engine in order to produce a feeling of operating a powerful gasoline powered car. As described above, the system operates to transmit various environmental cues in a manner that magnifies the actual setting in which the driver is situated. For example, when driving across a bay, sounds of fog horns in the distance may be played in the interior of the vehicle.

The human brain is adept at filtering out at least two quite unnatural occurrences related to viewing entertainment. First, in movies, scenes switch one to the next in dramatic contrast to the smooth nature in real life by which our environment is perceived to change as one gazes in long “tracking shots” always from a point of view correlating to one’s eye locations. Second, musical scores enhance emotion in a rather unnoticeable manner. Were actual foreboding music to begin playing when opening a creaky barn door, it would cause one to question where the orchestra was located and, more precisely, why is an orchestra assembled in a field by a barn. The latter of these oddities represent opportunities for feeding data to the brains of drivers.

Because the system knows and displays environmental context data, it may use this data to provide a real-time, or anticipatory, “score” for a journey. As noted above, sounds of creaking ice may alert a driver to hazardous road conditions. Likewise, the playing of gathering low frequency sounds or string instruments may serve to put a driver on alert that something unexpected, such a traffic congestion, is fast approaching. In another embodiment, foreboding music may indicate arrival at the house of one’s mother in law.

In the instance when the system knows the route that a driver will be taking, in accordance with the preceding discussion, the system may display information related to a single journey considered as a unified whole. In instances where no route has been computed, the system may extrapolate a predetermined and/or dynamically scalable distance into the future and the past and use these as reference points for start point 102 and end point 104. In such an instance, progress indicator 106 may be permanently set half way between the pending points while the display of data moves right to left across the graphical element 100. For example, after traveling for ten minutes on a highway, the path stretching out behind the vehicle for several miles is known and it can be inferred that the driver will continue into the future on the same highway. In some instances, the distance displayed into the future may be less than the past distance, except, for example, when it is ascertained that there is a high degree of probability that the future route is known, as when the highway has no exits for several miles.

In accordance with various other additional exemplary embodiments, visual and audio data collected by vehicles may be aggregated and/or individually selected for collection and dissemination. In some instances, cameras arranged around the exterior of a vehicle may be utilized to acquire simultaneous or near simultaneous photos of the exterior surrounding a vehicle and may be subsequently stitched together to create a panoramic image of the surroundings. These resulting images may be archived for retrieval by the system. In some instances, the system may actively query vehicles to create the images. For example, with reference to FIG. 1A, pressing on the hazardous road conditions icon may cause the system to query for the identity of a vehicle currently experience the conditions to which the icon refers. The system may identify one or more vehicles experiencing the conditions and request real or near real-time photos of the environment. The system may stitch these photos together to create a panorama for viewing by any of the vehicle’s occupants, may produce a thumbnail rendering for presentation along the environment indicator 110 or may likewise make such data available to the vehicle’s occupants.

In this manner, each vehicle operates as ‘sensor platform for hire” by the system to gather and send back requested sensor data as needed.

In some embodiments, as described above, data may be received from one or more sensors on one or more vehicles via electronic communication and transmission by a centralized server. The centralized server, vehicles and computing devices may all comprise one or more processors and may all work either singularly or in combination to practice the embodiments described herein.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read. The terms “computer-readable memory” and/or “tangible media” specifically exclude signals, waves, and wave forms or other intangible media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, SAS™ by IGT, OASIS™ by Aristocrat Technologies, SDS by Bally Gaming and Systems, ATP, TCP/IP, GDS published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method comprising:
receiving geocoded status data from a plurality of sensors forming a part of a plurality of vehicles the geocoded status data being indicative of an environmental attribute of each of the plurality of vehicle’s location;
receiving geocoded weather data indicative of a weather phenomena over a geographic expanse;
determining based, at least, on the geocoded status data and the geocoded weather data, one or more road status attributes; and
transmitting the road status attributes to at least one of the plurality of vehicles for display to a driver of each of the plurality of vehicles.

2. The method of claim 1, where in the vehicle sensors are selected from the group consisting of an anti-breaking system, a windshield wiper apparatus, an interior temperature control system and one or more vehicle mounted cameras.
